(19) United States
(12) Patent Application Publication
(10) Pub. No.: US 2014/0183933 A1
(43) Pub. Date: Jul. 3, 2014

(54) METHOD OF DECELERATING A VEHICLE WITH REGENERATIVE AND FRICTION BRAKING

(71) Applicant: Robert Bosch GmbH, Stuttgart (DE)

(72) Inventor: Ryan Kuhlman, Novi, MI (US)

(73) Assignee: Robert Bosch GmbH, Stuttgart (DE)

(21) Appl. No.: 14/135,650

(22) Filed: Dec. 20, 2013

Related U.S. Application Data
(60) Provisional application No. 61/746,181, filed on Dec. 27, 2012.

(51) Int. Cl. B60T 13/58

(52) U.S. Cl. CPC B60T 13/586
USPC 303/3

(57) ABSTRACT

A method of decelerating a vehicle equipped with both regenerative powertrain braking from a motor/generator and friction braking from fluid pumped through a brake circuit. A deceleration demand is received, and regenerative braking torque is ramped up in response to the deceleration demand. The brake circuit is pre-charged during the ramping up of regenerative braking torque. Pre-charging the brake circuit includes pumping fluid to at least one wheel cylinder braking device to reduce the required pump speed and resulting noise for any subsequent braking demand on the brake circuit. The pump is actuated to operate at a predetermined speed that maintains noise and vibration below predetermined levels.

### CROSS-REFERENCE TO RELATED APPLICATIONS

The present application claims priority to U.S. Provisional Patent Application No. 61/746,181, filed Dec. 27, 2012, the entire contents of which are incorporated by reference herein.

### BACKGROUND

The present invention relates to vehicle braking systems. More particularly, the invention relates to a method of responding to braking demands in a vehicle with both regenerative powertrain braking and hydraulic-actuated friction braking.

### SUMMARY

In one aspect, the invention provides a method of decelerating a vehicle equipped with both regenerative powertrain braking ability from a motor/generator in the vehicle drive train and friction braking ability from fluid pumped through a brake circuit to at least one wheel cylinder braking device. A deceleration demand is received, and regenerative braking torque is ramped up in response to the deceleration demand. The brake circuit is pre-charged during the ramping up of regenerative braking torque. Pre-charging the brake circuit includes pumping fluid to at least one wheel cylinder braking device to reduce the required pump speed and resulting noise for any subsequent braking demand on the brake circuit. The pump is actuated to operate at a predetermined speed that maintains noise and vibration below predetermined levels.

In another aspect, the invention provides a method of decelerating a vehicle which is equipped with both regenerative powertrain braking ability from a motor/generator in the vehicle drive train and friction braking ability from fluid pumped through a brake circuit to at least one wheel cylinder braking device. A deceleration demand above a coasting deceleration of the vehicle is identified. Regenerative braking is ramped up in response to the deceleration demand. A pump in the brake circuit is run at a predetermined speed, not dependent upon the deceleration demand to apply a minority fraction of friction braking simultaneously with the ramping up of regenerative braking.

Other aspects of the invention will become apparent by consideration of the detailed description and accompanying drawings.

### BRIEF DESCRIPTION OF THE DRAWINGS

FIG. 1 is a graph of brake torque versus time for a brake intervention with friction braking torque.

FIG. 2 is a graph of brake torque versus time for a brake intervention with regenerative braking torque.

FIG. 3 is a graph of brake torque versus time for a brake intervention with regenerative braking torque and friction braking torque, where regenerative braking is maximized and then supplemented with friction braking torque.

FIG. 4 is a graph of brake torque versus time for a method of the present invention, where friction braking torque is initialized prior to regenerative braking reaching its maximum.

FIG. 5 is a graph of brake torque and pump speed versus time, illustrating various schemes for pumping a fixed volume of fluid.

FIG. 6 is a graph of brake torque versus time for a method where friction braking torque is initialized prior to regenerative braking reaching its maximum, but after regenerative braking is initialized.

FIG. 7 is a graph of brake torque versus time for a method similar to that shown in FIG. 4, but illustrating a limited pre-charge of friction torque.

FIG. 8 is a graph of brake torque versus time for a method similar to that shown in FIG. 6, but illustrating a limited pre-charge of friction torque.

FIG. 9 is a graph of fluid volume versus pressure for an exemplary braking circuit, including one front wheel cylinder brake device and one rear wheel cylinder brake device.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

A vehicle may be equipped with multiple braking systems that can single-handedly or cooperatively decelerate the vehicle in response to driver request or a driver intervention system, such as adaptive cruise control or autonomous emergency braking for collision avoidance. For example, many hybrid vehicles include a powertrain having an electric motor/generator, which is operable in a generator mode to decelerate the vehicle with regenerative braking, which also recovers energy to store in a battery pack. Thus, regenerative braking enhances the efficiency of the vehicle. However, such vehicles generally still require a foundation braking system with wheel cylinder braking devices (e.g., piston calipers) operable to perform friction braking when actuated through a brake circuit with hydraulic fluid. The foundation braking system operates by pressurizing hydraulic fluid in the brake circuit and is not subject to the inherent limitations of regenerative braking, which has a maximum deceleration effect that may not be enough for some braking demands. Regenerative braking effect is also speed dependent, decreasing significantly at lower vehicle speeds. Therefore, it can be desirable or necessary to combine or blend the braking effects from both regenerative and friction braking during a deceleration event.

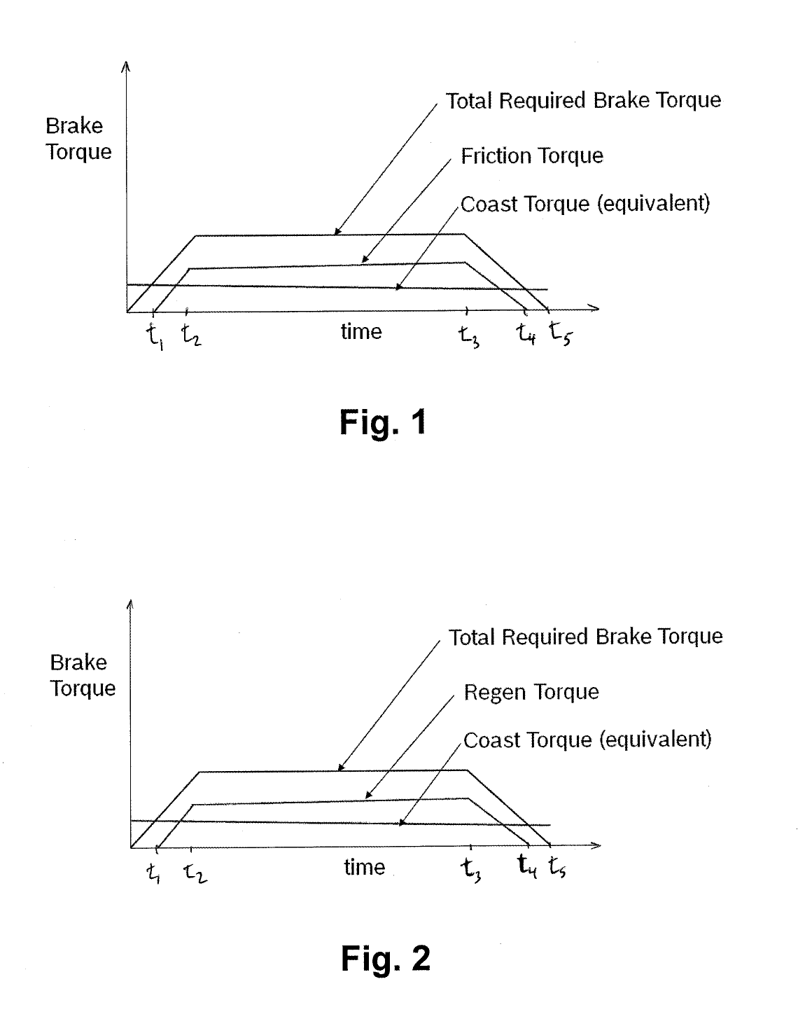

FIG. 1 illustrates a brake torque versus time graph for a brake intervention with friction braking torque only. For example, in a conventional (non-hybrid) vehicle, an adaptive cruise control system may signal to a controller to decelerate the vehicle upon a radar sensor signal determining that a distance to a leading vehicle is decreasing. A total required brake torque ramps up from initial time to a steady value at time t₂, which is maintained until time t₃ and then decreases to zero at time t₅ when deceleration is complete. A coast torque of the vehicle acts, regardless of active braking, to provide a slight deceleration attributable to rolling resistance and wind resistance. Thus, friction braking torque begins at time t₁ only after the total required brake torque exceeds the coast torque. The friction braking torque increases from time t₁ to time t₂, with a slope approximately equal to the slope of the total required braking torque. As seen in FIG. 1, the coast torque decreases slightly over time, since the vehicle encounters less wind resistance as speed decreases. As the total required brake torque decreases from time t₃ to time t₅, the friction braking torque drops back to zero at time t₄, as soon as the coast torque alone is sufficient to complete the deceleration event. Because the braking intervention occurs as part of an adaptive cruise control program, without specific driver input to the braking system, the pressure in the brake circuit to be applied to the wheel cylinder braking devices is generated by a pump within the brake circuit in an on-demand manner. In other words, hydraulic fluid is not first stored under pressure in any accumulator. Thus, the slope of the line representing the ramp up of friction braking torque is also representative of the required pump speed. As such, the slope of the total required brake torque dictates the pump speed for the friction brakes to meet the demand during a brake intervention that requires friction braking This is generally not a concern in conventional automobiles having internal combustion engines, which have a certain expected amount of underlying vehicle noise and vibration during operation.

FIG. 2 illustrates a graph of brake torque versus time for a brake intervention with regenerative braking torque only. For example, in a hybrid or full electric vehicle, an adaptive cruise control system may signal to a controller to decelerate the vehicle upon a radar sensor signal determining that a distance to a leading vehicle is decreasing. A total required brake torque ramps up from initial time to a steady value at time t₂, which is maintained until time t₃ and then decreases to zero at time t₅ when deceleration is complete. The coast torque of the vehicle is present at all times, regardless of active braking Thus, regenerative braking torque is initialized at time t₁ only after the total required brake torque exceeds the coast torque. The regenerative braking torque increases from time t₁ to time t₂, with a slope approximately equal to the slope of the total required braking torque. As described above, the coast torque decreases slightly over time. As the total required brake torque decreases from time t₃ to time t₅, the regenerative braking torque drops back to zero at time t₄, as soon as the coast torque alone is sufficient to complete the deceleration event. As long as the total required brake torque, less the available coast torque, does not exceed the regenerative braking capability, no friction braking is required and the pump in the brake circuit of the foundation braking system is not actuated at all. This is often preferred in order to maximize the amount of energy that can be stored to the batteries during regenerative braking and also conserve energy spent on running the pump.

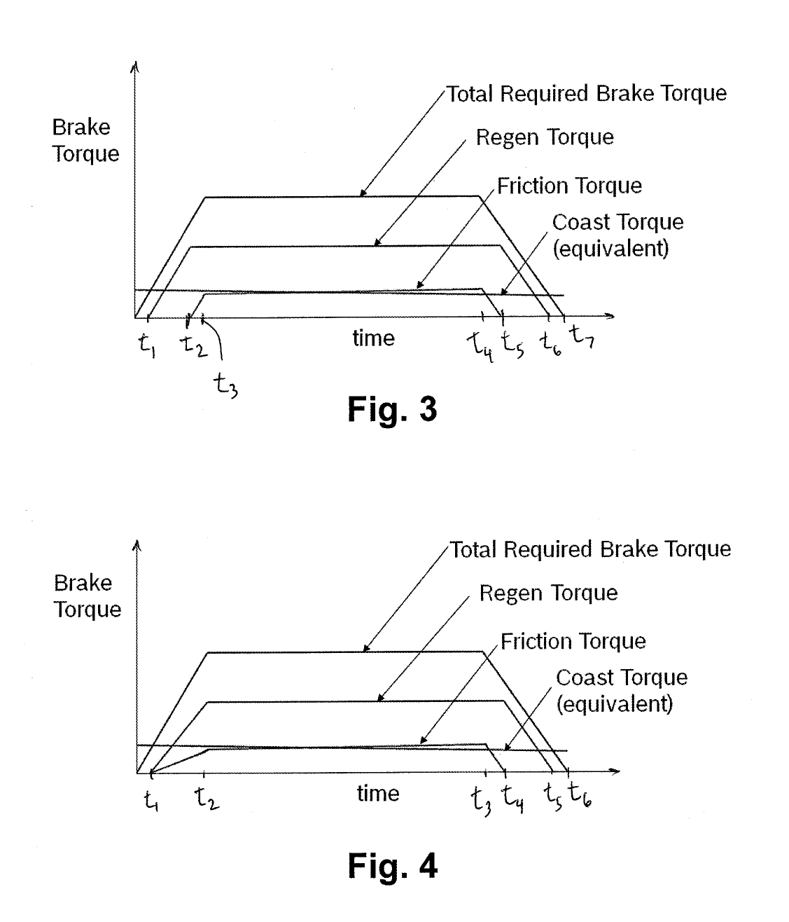

However, regenerative braking alone is not capable of meeting every deceleration demand, and must be supplemented by friction braking in some instances. The graph of FIG. 3 illustrates brake torque versus time for a higher total required brake torque than that of FIGS. 1 and 2, and in particular, the total required brake torque exceeds that which can be met by regenerative braking torque. As shown in FIG. 3, regenerative braking begins at time t₁ and increases along with the total required brake torque until the maximum regenerative braking capability is reached at time t₂. At this time, friction braking is initialized to meet the latter part of the increase in total required brake torque until stabilization at time t₃. When the total required brake torque begins to decrease at time t₄, friction braking decreases first before regenerative braking torque begins to decrease at time t₅. Once the coast torque is sufficient to complete the deceleration event, regenerative braking torque ceases at time t₆. The deceleration event ends at time t₇. Because regenerative braking is already maximized by time t₂, the slope of the line for the building of friction torque must be approximately equal to that of the total required brake torque. Thus, the pump speed for the pump in the brake circuit is dependent upon the deceleration demand, and may be relatively high in some instances. The amount of noise and vibration due to the pump running at high speed may be rather conspicuous and undesirable. This is especially the case in a full electric vehicle that operates with very low underlying vehicle noise and vibration levels.

FIG. 4 is a graph of brake torque versus time that illustrates a method of the present invention in which an intelligent brake intervention is accomplished with regenerative braking torque and friction braking torque to eliminate excessive pump noise under most circumstances. For example, in a hybrid or full electric vehicle, an adaptive cruise control system may signal to a controller to decelerate the vehicle upon a signal from a radar sensor that indicates that a distance to a leading vehicle is decreasing. A total required brake torque ramps up from initial time to a steady value at time t₂, which is maintained until time t₃ and then decreases to zero at time t₆. The coast torque of the vehicle is present at all times, regardless of active braking Thus, regenerative braking torque is initialized at time t₁ to begin ramping up only after the total required brake torque exceeds the coast torque. Contrary to a scheme like that of FIG. 3 where regenerative braking is maximized before friction braking initializes, the method of FIG. 4 initializes friction braking at time t₁, simultaneous with the initialization of regenerative braking This is discussed in further detail below. When the total required brake torque begins to decrease at time t₃, friction braking decreases first before regenerative braking torque begins to decrease at time t₄. Once the coast torque is sufficient to complete the deceleration event, regenerative braking torque ceases at time t₅. The deceleration event ends at time t₆. Because friction braking torque builds during the ramping up of regenerative braking torque, the slope of the line for the building of regenerative braking torque is less than the slope of the total required braking torque. The slope of the friction torque line on the graph of FIG. 4, which correlates to the pump speed for the pump in the brake circuit, can be significantly less than the slope of the line for the total required braking torque. In fact, the pump speed can be independent from the deceleration demand indicated by the total required brake torque.

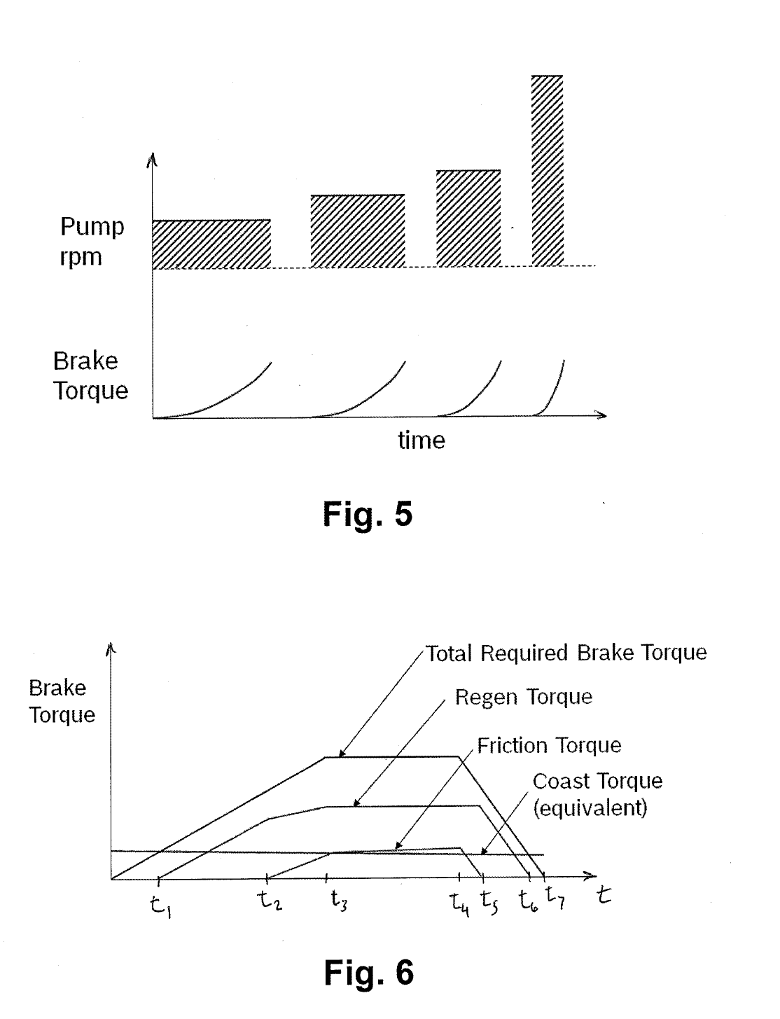

The method can include actuating the pump to run at a predetermined speed that achieves predetermined satisfactory noise and vibration levels. The pump can be actuated to effect friction braking in response to the demand for deceleration by regenerative braking, even though the deceleration demand is within the capability of regenerative braking alone and friction braking is not required to meet the immediate braking demand. The friction braking torque may be a minority portion of the total required brake torque while the pump runs at the predetermined speed during the build of regenerative braking torque. The initial running of the pump to build pressure in the brake circuit, more specifically pressure applied to one or more wheel cylinder braking devices of the brake circuit to effect friction braking, accomplishes a “pre-charging” of the brake circuit that reduces the required pump speed and resulting noise for any subsequent braking demand on the brake circuit. In the example of FIG. 4, friction braking torque builds between times t₁ and t₂ and then remains steady (only increasing slightly to account for the gradual reduction in coast torque). However, in the case of a sudden increase in total required brake torque while regenerative braking is already maximized, the pump in the brake circuit must build the required pressure on-demand. Any such demand inherently requires lower pump speed when the brake circuit has already been pre-charged by running the pump between times t₁ and t₂. The pre-charging of the brake circuit can be accomplished by running the pump at the predetermined speed for a predetermined amount of time or number of cycles, thereby achieving a predetermined pumped fluid volume corresponding to a predetermined brake circuit pressure (e.g., about 3 to 5 bar). As long as the deceleration demand is not of the type that immediately exceeds the regenerative braking capability, the initial running speed of the pump and the predetermined pumped fluid volume during pre-charging can be predetermined as fixed values. In other words, as long as the total required brake torque does not exceed what can be achieved, at least initially, through regenerative braking (in combination with the inherent coast torque), the pump will pre-charge the brake circuit in the same manner for any given deceleration demand. FIG. 5 illustrates four various schemes for building a predetermined pumped fluid volume. From left to right, the slope of each brake torque line increases, representing a faster running speed. On the left, the pump is run at a slow speed and generates the predetermined pumped fluid volume over a longer period of time. Each successive plot further to the right represents a faster running speed by which the predetermined pumped fluid volume can be achieved over a shorter period of time. The method described above is achieved by selecting a particular pre-charging characteristic for running the pump in the brake circuit, such that the predetermined pumped fluid volume is built in an acceptable amount of time while maintaining noise and vibration levels below predetermined levels. Only by starting the pump early and applying a small amount of friction braking prior to exceeding the maximum regenerative braking capability can a relatively slow pump speed be selected and relied upon.

Although a very small penalty in regenerative braking efficiency (total energy storage to the batteries for a given deceleration) may be incurred by beginning friction braking at time t₁ instead of waiting for regenerative braking to be maximized, a dramatic reduction in friction braking intervention noise and vibration can be achieved, which can have a far greater positive effect on overall satisfaction of the driving experience. This is especially true in a full electric vehicle that operates with very low levels of baseline noise and vibration.

FIG. 6 illustrates a modified method, similar to that shown in FIG. 4. Like that described above with reference to FIG. 4, friction torque is built up by running the pump while regenerative torque is still ramping up (i.e., not yet maximized). However, in the method of FIG. 6, friction torque is not initialized until time t₂, after a delay from time t₁, where regenerative braking torque begins to ramp up. While keeping the benefit of pre-charging the brake circuit prior to reaching the maximum capability of regenerative torque to enable good response without high pump speed, the method of FIG. 6 further reduces any detrimental effect on regenerative braking efficiency by allowing the regenerative braking to act alone to capture maximum energy when the vehicle is moving fastest, at the initial portion of the deceleration cycle. A system controller can determine an appropriate delay between the start of regenerative braking and the start of friction braking, and may prevent the pump from running at all in circumstances when an entire deceleration event can be met with regenerative braking alone. The method can include determining whether or not friction braking will be required as a supplement to regenerative braking at a time prior to exceeding maximum regenerative braking capability to allow pre-charging of the brake circuit to be completed. This may include taking into consideration factors such as vehicle speed, battery state of charge, etc. Determining the time at which to start the pump for pre-charging can be calculated by determining the time required to complete the pre-charge, the anticipated maximum regenerative torque capability for the current conditions, and the expected final total required brake torque target. By delaying pre-charging of the brake circuit until it is determined that friction braking supplementation will be needed, a relative maximization of regenerative braking efficiency can be achieved. It should be understood that the final target for total required brake torque may not be known in advance, and in such situations, the gradient can be used as an indicator to whether or not friction torque will be necessary and at what time during the deceleration event.

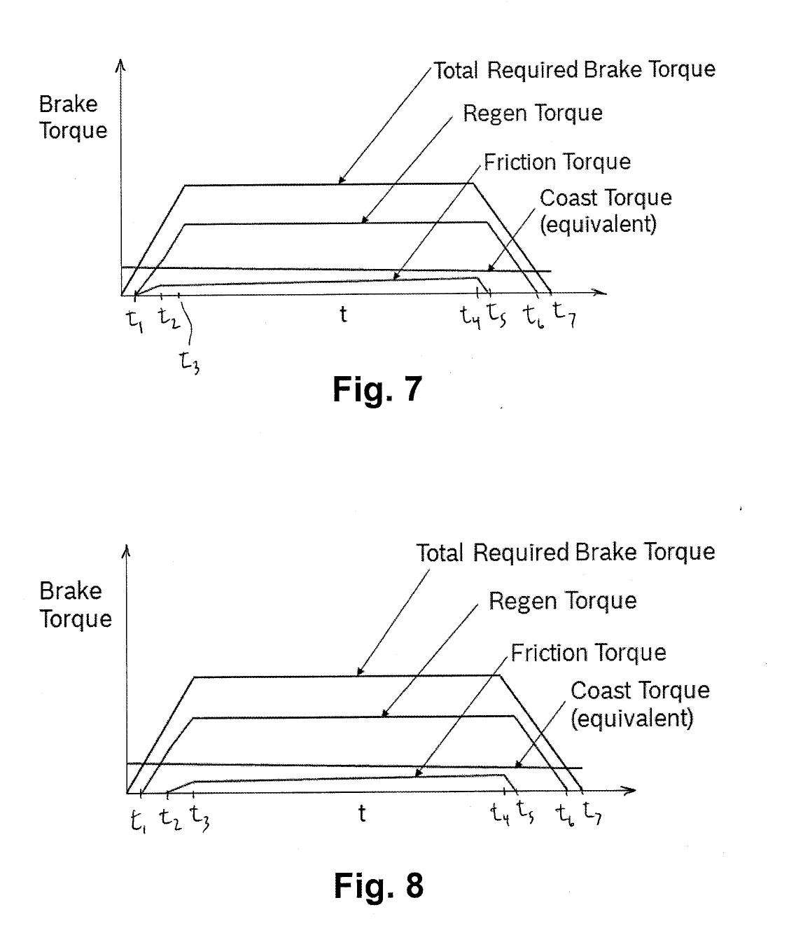

FIG. 7 illustrates another modification of the method described with respect to FIG. 4. Although the pre-charge of the brake circuit begins at time t₁, simultaneous with the ramping up of regenerative braking, a full capacity pre-charge is not completed. Rather, upon determining that an amount of friction braking supplementation above the maximum regenerative braking capability is less than the amount provided by a full pre-charge, the running of the pump can be stopped at time t₂ prior to pumping the predetermined amount of fluid for a full pre-charge. Because the speed of the pump is the same as that of FIG. 4, which can be a predetermined minimum pump speed used for all pre-charging events, the duration of pumping is simply shortened. Thus, the pre-charging is completed prior to regenerative torque reaching its maximum capability at time t₃. In this way, the amount of pre-charge can be variable in response to the total required brake torque to help maximize regenerative braking efficiency, even though the basic scheme of pre-charging prior to friction braking necessity, and running the pump at the predetermined pre-charging speed are the same as described above with respect to FIG. 4.

FIG. 8 illustrates yet another modification of the method of FIG. 4. In the method of FIG. 8, strategies from the methods of FIGS. 6 and 7 are combined. In other words, the pre-charging of the brake circuit is delayed as long as possible while still being completed by the time regenerative braking is maximized, and the amount of the pre-charge is a reduced amount below a full pre-charge volume and corresponding pressure.

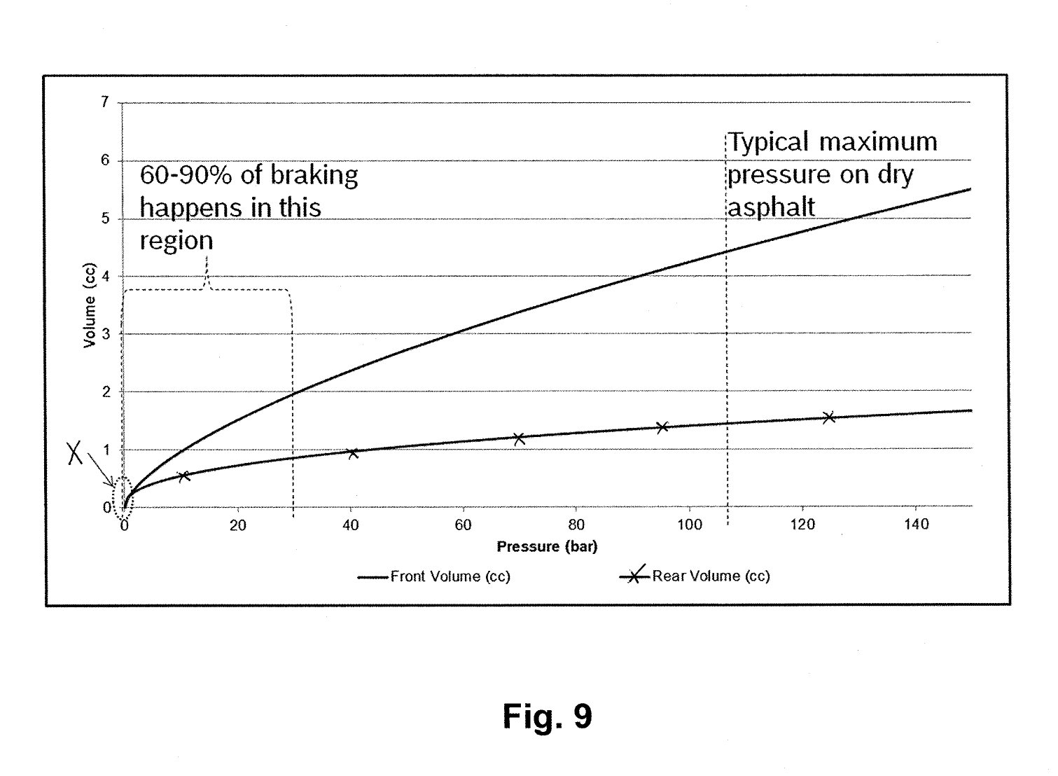

FIG. 9 illustrates a volume versus pressure graph or “PV curve” for the fluid of an exemplary brake circuit including one front wheel cylinder brake device and one rear wheel cylinder brake device. As noted in the area marked by arrow X, there is an initial area of “soft” response in which the slope is relatively high and pressure does not build very quickly with increased volume. The pre-charging of the brake circuit as described above can put the brake circuit outside this soft portion of the PV curve so that later brake intervention by pumping takes place in the more responsive portion of the PV curve. As mentioned above, this may correspond to a full pre-charge of about 3-5 bar of pressure built within the brake circuit.

Although the above description makes specific mention of a method used in conjunction with adaptive cruise control, using radar sensors, the usefulness of the invention may not be limited to such an implementation of adaptive cruise control, and may not be limited to adaptive cruise control at all. Various features and advantages of the invention are set forth in the following claims.

What is claimed is:

1. A method of decelerating a vehicle which is equipped with both regenerative powertrain braking ability from a motor/generator in the vehicle drive train and friction braking ability from fluid pumped through a brake circuit to at least one wheel cylinder braking device, the method comprising:
receiving a deceleration demand above a coasting deceleration of the vehicle;
ramping up regenerative braking torque in response to the deceleration demand;
pre-charging the brake circuit during the ramping up of regenerative braking torque, wherein the pre-charging of the brake circuit includes pumping fluid to the at least one wheel cylinder braking device to reduce the required pump speed and resulting noise for any subsequent braking demand on the brake circuit,
wherein the pump is actuated to operate at a predetermined speed that maintains noise and vibration below predetermined levels.

2. The method of claim 1, wherein the demand for deceleration is identified as a deceleration demand that can be at least initially met without exceeding a maximum capability of the regenerative braking from the motor/generator.

3. The method of claim 2, wherein the predetermined speed is preselected, irrespective of the deceleration demand.

4. The method of claim 2, further comprising running the pump at the predetermined speed until the maximum regenerative braking capacity is reached.

5. The method of claim 1, further comprising running the pump at the predetermined speed until a predetermined volume of fluid has been moved through the braking circuit to the at least one wheel cylinder braking device.

6. The method of claim 1, wherein the deceleration demand occurs in response to a signal from an adaptive cruise control system of the vehicle.

7. The method of claim 6, wherein the signal is generated from a radar sensor.

8. The method of claim 1, wherein the demand for deceleration occurs without demand from a driver of the vehicle.

9. The method of claim 1, further comprising ramping up regenerative braking torque to a maximum regenerative braking capability, maintaining regenerative braking at the maximum regenerative braking capability, and meeting a braking demand above the maximum regenerative braking capability via further pumping of the fluid within the brake circuit.

10. The method of claim 1, wherein the pump is actuated to begin running as soon as regenerative braking is enacted.

11. A method of decelerating a vehicle which is equipped with both regenerative powertrain braking ability from a motor/generator in the vehicle drive train and friction braking ability from fluid pumped through a brake circuit to at least one wheel cylinder braking device, the method comprising:
identifying a deceleration demand above a coasting deceleration of the vehicle;
ramping up regenerative braking in response to the deceleration demand; and
running a pump in the brake circuit at a predetermined speed, not dependent upon the deceleration demand to apply a minority fraction of friction braking simultaneously with the ramping up of regenerative braking.

12. The method of claim 11, wherein the demand for deceleration is identified as a deceleration demand that can be at least initially met without exceeding a maximum capability of the regenerative braking from the motor/generator.

13. The method of claim 12, further comprising running the pump at the predetermined speed until the maximum regenerative braking capacity is reached.

14. The method of claim 11, wherein the pump is actuated to begin running as soon as regenerative braking is enacted.

15. The method of claim 11, further comprising running the pump at the predetermined speed until a predetermined volume of fluid has been moved through the braking circuit to the at least one wheel cylinder braking device.

16. The method of claim 11, wherein the deceleration demand occurs in response to a signal from an adaptive cruise control system of the vehicle.

17. The method of claim 16, wherein the signal is generated from a radar sensor.

18. The method of claim 11, wherein the demand for deceleration occurs without demand from a driver of the vehicle.

19. The method of claim 11, wherein the pump is run at a predetermined speed that maintains noise and vibration below predetermined levels.

20. The method of claim 11, further comprising ramping up regenerative braking torque to a maximum regenerative braking capability, maintaining regenerative braking at the maximum regenerative braking capability, and meeting a braking demand above the maximum regenerative braking capability via further pumping of the fluid within the brake circuit.
